(19) United States
(12) Patent Application Publication
(10) Pub. No.: US 2002/0062310 A1
(43) Pub. Date: May 23, 2002

(54) Peer-to-peer commerce system

(75) Inventors: Michael Marmor, Jersey City, NJ (US); James de Jager, Jersey City, NJ (US); Robert Day, New York, NY (US); Michael J. Boeglin, Rego Park, NY (US); Neeraj Kumar, Hyderabad (IN)

Correspondence Address: DARBY & DARBY, 805 THIRD AVENUE, 27TH FLR., NEW YORK, NY, 10022, US

(73) Assignee: Smart Peer LLC

(21) Appl. No.: 09/955,925

(22) Filed: Sep. 18, 2001

Related U.S. Application Data
(60) Provisional application No. 60/241,895, filed on Oct. 20, 2000.
(60) Provisional application No. 60/233,332, filed on Sep. 18, 2000.

(51) Int. Cl. G06F 7/00; G06F 17/30

(52) U.S. Cl. 707/3; 707/10

(57) ABSTRACT

A peer-to-peer commerce system in part relies on being able to identify the geographic location of the electronic devices, e.g., computers or palm pilots. Where the computer or device is stationary, this can be indicated by inserting a zip code, address or telephone number in the computer code identifying the device. Where the device is mobile, this can be indicated manually in a similar fashion. In addition, global positioning satellite (“GSP”) devices may be incorporated with the device to give geographic location automatically. Further, if the device is a cellular telephone device, the cellular device has location information in terms of identifying the cell in which the device is broadcasting. The peer-to-peer search is passed simultaneously over various branches of a binary tree to applications controlling databases for various businesses. Each business application checks the query against the information on its database and provides it to the requesting computer when available.

The present invention relates to, and claims priority of, U.S. Provisional Patent Application Serial No. 60/233,332 filed on Sep. 18, 2000, having the same title as the present invention, which is incorporated herein by reference.

### BACKGROUND OF THE INVENTION

This invention relates to peer-to-peer electronic communications and, more particularly, to a peer-to-peer commerce system in which the location of information about products in databases of computers using the system is determined by users by simultaneously searching diverse databases.

The decreasing cost of high speed Internet connections and the omnipresence of powerful network-ready personal computers has lead to the development of global peer-to-peer (P2P) networking. In a peer-to-peer network, computers communicate with each other directly, rather than each communicating with a centralized server. Each participating computer, called a “host” or a “node”, is responsible for relaying data from other participating computers. This eliminates the need for traditional servers and forms a fault-tolerant network that is not dependant on any central point.

Small-scale P2P networks are not new. They have been used for years in local-area workgroups made popular by operating systems from Apple and Microsoft. However, in recent years global peer-to-peer applications have become popular. They use the Internet to connect hundreds of thousands of computers. Such large-scale P2P networks are currently in their infancy. Existing protocols and software for them are limited and require additional functionality and security before mainstream businesses and consumers can begin to adopt them. Those constraints notwithstanding, P2P technology is compelling both in its present applications and in its prospect for the future.

Global P2P networks are made possible by specialized communications protocols and software that enables each host computer to function as both a client and a server. The Gnutella protocol was designed to facilitate file searches in this distributed, global P2P environment. Gnutella is a real-time search, peer-based file-sharing protocol that allows a user running a Gnutella client to search for and download files from other Gnutella users. To use the Gnutella protocol, a software application called a “servent” (server+client=servent) is run on each node in the P2P network. The servent application provides a user interface that can be used to make searches, view results, download files and interact with other users in the network. The servent software also makes designated files available to the network by accepting queries from other network users and responding to appropriate queries with search results.

Gnutella is not the only P2P file sharing protocol in use, but it is the most functionally agnostic and can be easily extended from simple file sharing to more general data and information sharing. There are many servent applications that currently support the Gnutella protocol including Toadnode, Gnotella, N-Tella, Gnucleus, and GNUgnutella.

As noted, instead of searching a centralized server, the Gnutella protocol allows you to find other Gnutella users online—who have already found four or five other users online—and those four or five have found their own four or five users, etc. The Gnutella protocol allows you to search every one of those users' shared files using keywords. Only files that are designated as “shared” on the computers or nodes of the individual users are made available to the network. When a match is found, the servent software causes it to appear in a list on the computer of the user. By clicking on a choice of files, a downloading process is initiated and the files are transferred to the requesting computer.

The most ubiquitous use of P2P on the Internet is in the exchange of music files. However, there has been very little, if any, traditional commercial use of this technology. Currently, in order to have a meaningful e-commerce presence, a company must invest millions of dollars in technology, services and related software and hardware, as well as in marketing and promoting e-commerce initiatives. Further, such a company must deal with the high costs of overhead and ongoing maintenance of the solution. Realistically, this means that only large organizations can afford the time and expense required to establish a scalable Web-based e-commerce presence. Even then, these e-commerce sites are difficult, if not impractical or impossible, to access using a wireless device. The fundamental challenge therefore, is to make e-commerce more accessible and practical for everyone.

### SUMMARY OF THE INVENTION

The present invention is directed to providing ways to allow the use of peer-to-peer computer networks for typical commercial transactions, i.e., transactions in which a merchant sells a product to a customer, as opposed to transactions in which individuals merely exchange computer files.

In an illustrative embodiment of the invention, the existing inventory or point of sale (POS) system of a business is provided with geographical information, e.g., identifying the location of stores that have specific products. The inventory or POS system is connected to a query processor that can be customized for the system. This processor also runs P2P global software and is connected to the Internet. Because the inventory and location information is in shared files, customers using the P2P software can locate specific products and the stores where they can be found. In effect, any business placing its inventory in a shared file on the P2P network, puts that inventory in the search path of any potential customer using the network to seek products of that type.

This technology does not require the business to establish and maintain an elaborate website in order to provide information to potential customers. Further, there is no need to rely on Internet service providers or web browsers to direct customers to the site.

Customers benefit because the system allows them to search for and compare products in thousands of businesses and locations simultaneously, through a single query. This information concerns the product, its cost and availability, and is up-to-date because it comes from the business' current inventory or POS system. Further, the business does not have to duplicate this information on a stand alone website. In addition, the software is set up so the customer can make a direct purchase from the vendor identified in response to a P2P inquiry. This can be accomplished by having a purchase charged to a credit card or directly added to their wireless telephone bill. By using a digital receipt or order confirmation number which is easily verifiable by the merchant, the customer can pick up the purchase at the store, or have it delivered to a convenient address.

If the P2P customer is using a mobile device (e.g., a cellular phone, a laptop with a wireless Internet connection or a personal digital assistant (PDA) with a wireless Internet connection) to connect to the Internet, the current location of the customer may be indicated. This may be by a direct input by the user, global positioning satellite if the mobile device is so equipped or by cell site triangulation if the cellular system provider makes that service available. With such information, the P2P software on the customer's device sorts the responses from the computers on the network which have information relevant to an inquiry by their geographic proximity to the mobile device. As a result, the customer searching for a particular product may not only learn which company has the product, but which is closest to the user's current location.

### BRIEF DESCRIPTION OF THE DRAWINGS

The foregoing and other features of the present invention will be more readily apparent from the following detailed description and drawings of an illustrative embodiment of the invention in which:

FIG. 1 is a diagram showing a P2P Ping operation;

FIG. 2 is a diagram showing a P2P Pong operation;

FIG. 3 is a diagram showing a P2P Query operation;

FIG. 4 is a diagram showing a P2P Query Hit operation;

FIG. 5 is a diagram showing a P2P HTTP GET operation;

FIG. 6 is a diagram showing a P2P Push operation;

FIG. 7 is a diagram showing how the present invention makes the current inventory records of a business available over the Internet through peer-to-peer technology;

FIG. 8 is a block diagram of a network for implementing the present invention;

FIG. 9 is a diagram illustrating the creation of a user request according to the invention;

FIG. 10 is a diagram illustrating the distribution of a user request over the network according to the invention;

FIG. 11 is a diagram illustrating the search of a plurality of databases in response to a distributed query; and

FIG. 12 is a messaging sequence diagram illustrating the process of the present invention.

### DESCRIPTION OF ILLUSTRATIVE EXEMPLARY EMBODIMENTS

In order to operate the network of the present invention, a peer-to-peer (P2P) communications protocol and software are necessary. One such protocol is Gnutella. A servent application compatible with Gnutella and useful with the present invention is Toadnode™ or SmartPeer™. Toadnode can be downloaded at www.toadnode.com. Thus, a general review of the Gnutella compatible protocol used by, e.g. Toadnode™, is useful in understanding how global P2P networks function and provide an environment for the present invention.

The Gnutella protocol defines the way that applications communicate over the Internet. It is helpful to think of the P2P network as a conversation between computers. Some computers are “talking” while others are “listening”. To coordinate this conversation packets are tagged with special descriptors so that each computer receiving the packet knows how to react. The current Gnutella protocol (version 0.4) defines five descriptors: Ping, Pong, Query, QueryHit and Push (Table 1).

TABLE 1
Gnutella Protocol

| Packet Type | |
|---|---|
| (function identifier) | Purpose |
| Ping | A Ping packet is used to announce the user |
| | computer's presence on the network. When |
| | another computer receives the Ping, it will |
| | respond with a Pong packet. |
| Pong (Ping reply) | A Pong packet contains an IP address, port |
| | number, and information about how much data |
| | is being shared by the computer that sent the |
| | Pong. |
| Query | Query packets create a message which asks |
| | other computers if they are sharing specific |
| | content. When another computer has a match |
| | for the query, it will respond with a QueryHit |
| | packet. |
| QueryHit (Query reply) | A QueryHit packet is sent in response to a |
| | Query packet. It contains the IP address of the |
| | computer with the match and the name of the |
| | matching file or files. |
| Push Request | The Push packet informs a firewalled computer |
| | that the user would like to download a file, but |
| | cannot manage to initiate an HTTP connection. |
| | Upon receiving the push request the firewalled |
| | computer initiates an HTTP connection to the |
| | user's computer. |

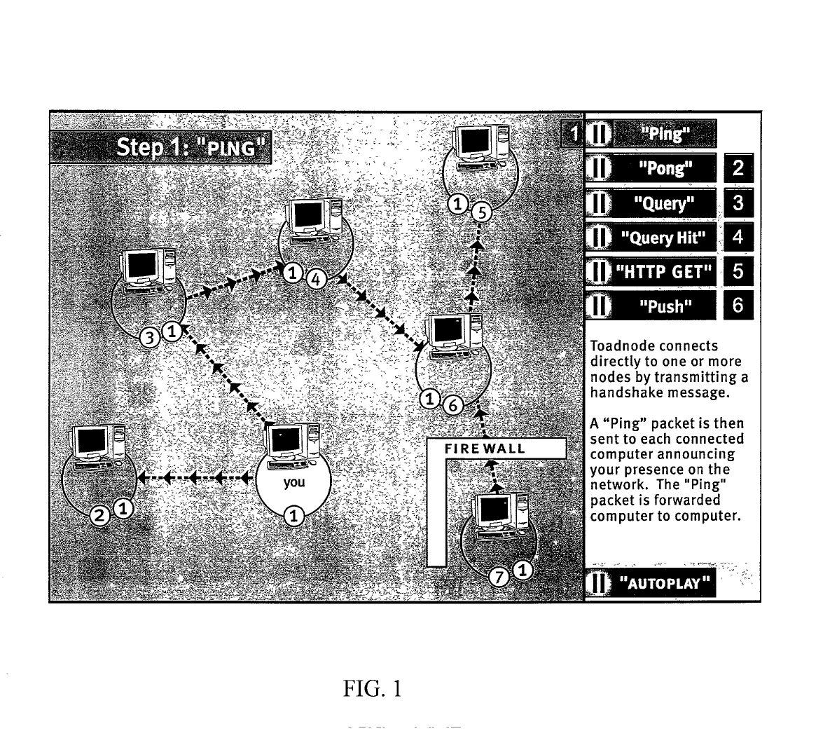

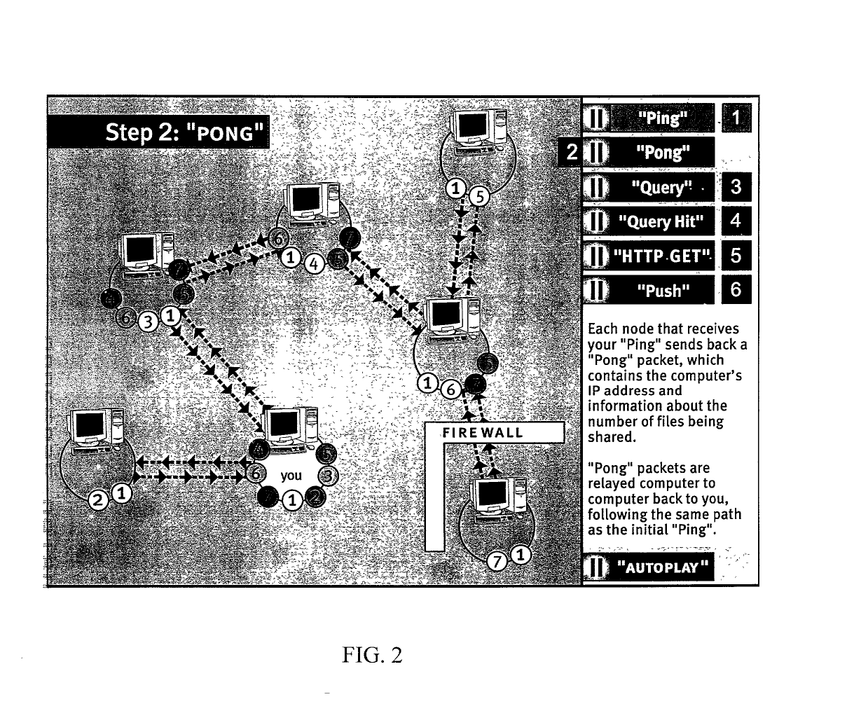

A “Ping” packet is used to announce the presence of a user on the network. (FIG. 1) When another computer receives the Ping, it will respond with a “Pong” packet (FIG. 2). It will also forward the Ping packet to other computers to which it is connected and, in response, they too will send back Pong packets. Each Ping and Pong packet contains a Globally Unique Identifier (GUID). A Pong packet also contains an IP address, port number, and information about how much data is being shared by the computer that sent the Pong. Pong packets are not necessarily returned directly to the point of origin, instead they are sent from computer to computer via the same route as the initial Ping. After sending a Ping to one computer, the computer that initiated the Ping will start receiving many Pong responses via that one computer. In effect the Pong packets provide information on who the active peers are to the originating computer, so it can start making searches of the available shared data on these computers.

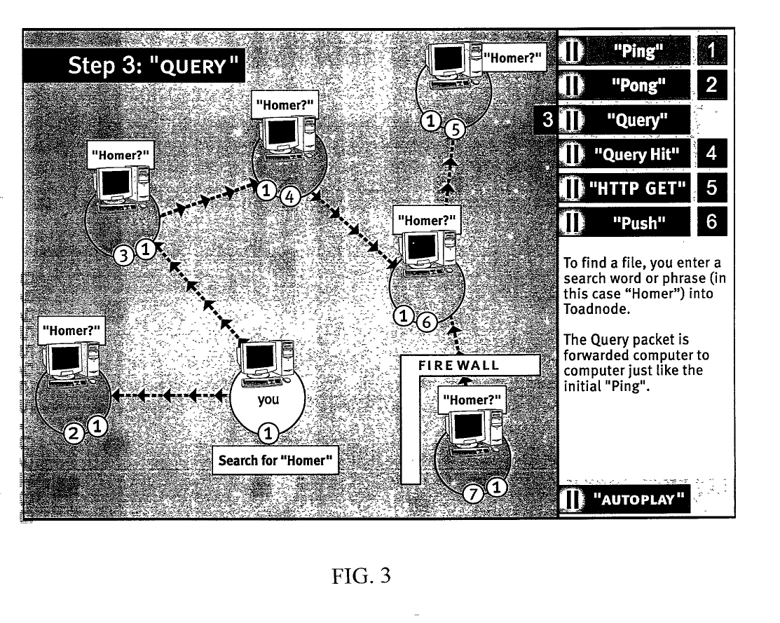

The Gnutella protocol allows for distributed searches. “Query” packets cause the search to be conducted by asking other computers if they are sharing specific content (and have an acceptably fast network connection)(FIG. 3). A Query packet might ask, “Do you have any content that matches the string 'Homer”? This question is sent to all the computers that returned Pong packets to the originating computer. Each of these computers does two things. First, each computer checks to see if it has any content that matches the search string. In this case it looks to see if there are any files in a specified directory marked “sharable to the outside world” that have the letters “Homer” in their complete file path. Second, each computer sends the Query packet on to all the computers to which it is connected. These computers check their directories or indexes and send the Query packet to all their connected computers. This process continues until you run out of computers to ask or until the Query packet gets too old and times out.

This last detail is important because without a pre-defined Time To Live (TTL) the Query packet could get bounced around for a very long time, potentially forever. Most servents, including Toadnode™ or SmartPeer™, allow the TTL to be adjusted. GUIDs in each packet are used to make sure that the same message does not get passed to the same computer again and again, creating a loop.

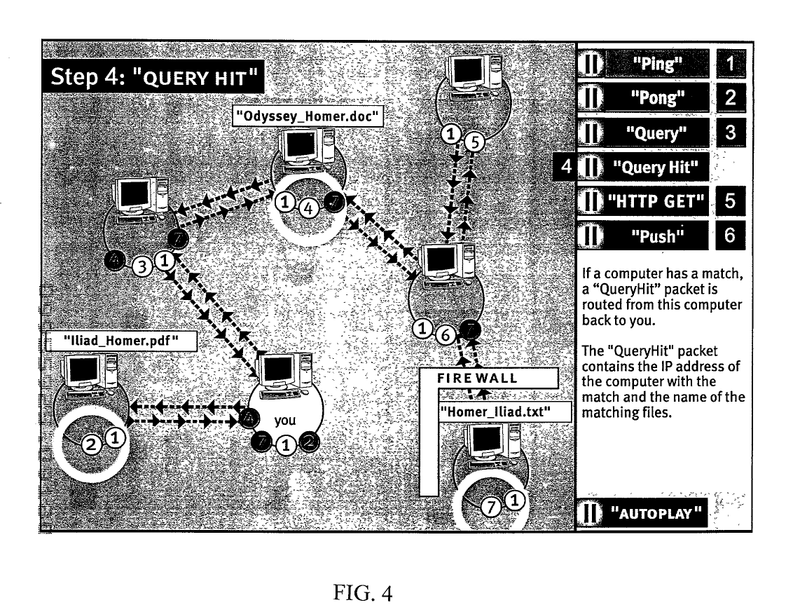

By the time the user is ready to download the requested information, the question asked in the Query packet has been distributed to a huge number of computers. Each computer has checked its shared information and determined if it is sharing anything that matches “Homer”. If for example, there are three computers that received the Query packet and have a match for “Homer,” then means must be provided to get this content to the requesting computer. The last two packet descriptors, called “QueryHit” and “Push,” are responsible for content delivery. Each of the three computers will send a QueryHit packet to the originating user's computer via the same delivery route, computer-to-computer, that the Query packet originally traveled (FIG. 4). The QueryHit packet contains the IP address and GUID of the computer that has the data as well as information about the file that matched the query.

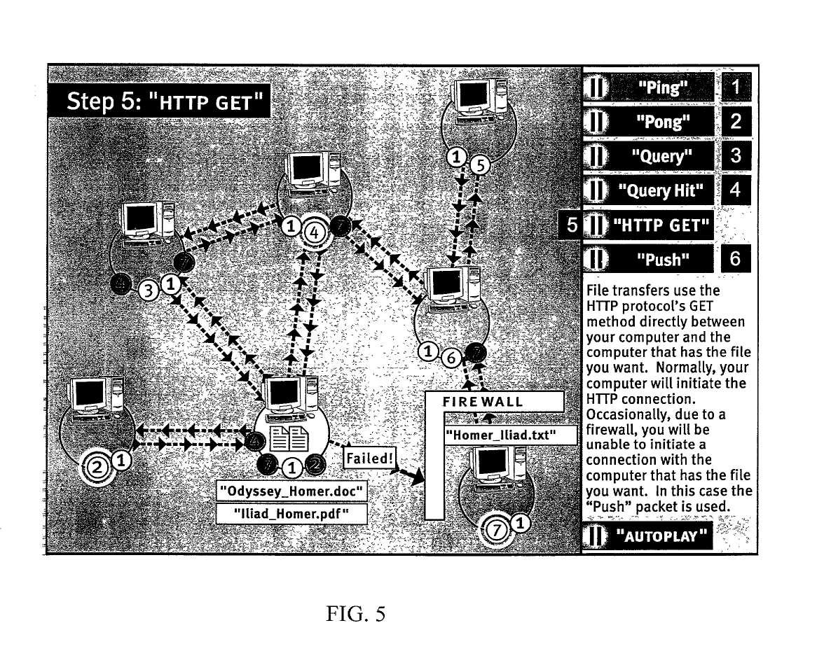

When a QueryHit packet is received at the originating computer, its servent software will display the name of the file and give the user the option to download it. File transfers use the HTTP protocol's GET method directly between the originating computer and the computer that has the file (FIG. 5). Normally, the originating computer will initiate the HTTP connection to the computer that has the file. Occasionally, due to a firewall, it will be unable to initiate a connection directly to the computer that has the file. In those cases the “Push” packet is used.

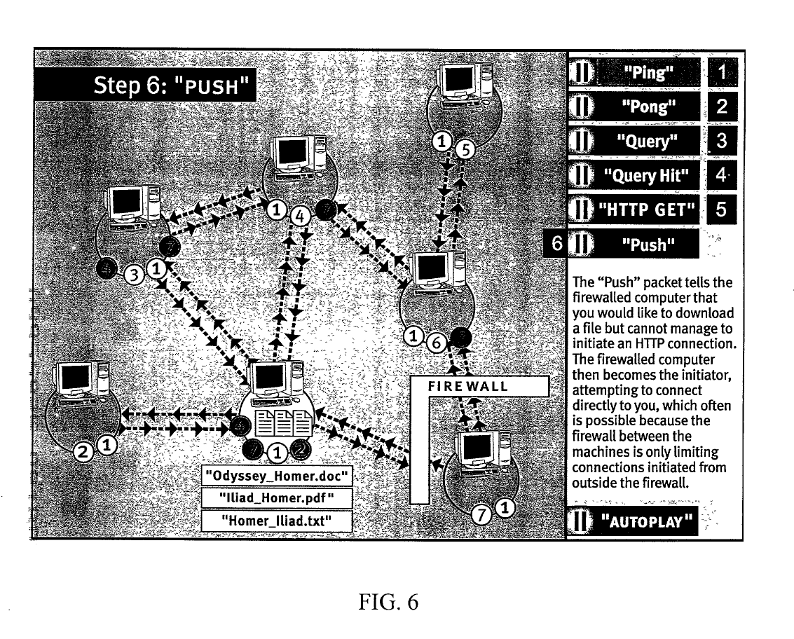

The Push packet (FIG. 6) allows a message to be delivered to the computer that has the file to download via the route that the QueryHit packet originally traveled, except in reverse. The Push packet tells this computer that the user would like to download a file but cannot manage to initiate an HTTP connection. This computer then becomes the initiator, attempting to connect directly to the originating computer, which often is possible because the firewall between the machines only limits connections initiated from outside the firewall.

A servent normally transmits the protocol handshake message and expects to receive the confirmation. In the Toadnode™ servent application, a change in this connection string message can be made by going to View, Options, Server, Advanced and typing in a custom connection. By changing the handshake message, a private community of users can be created that uses the same message. Thus, private subnets can be seamlessly connected, and one or more nodes simply connect to multiple subnets to provide routing. If the handshake message is changed, the user will not be able to communicate with the rest of the network, i.e., the communication remains private and inaccessible to the rest of the network—exactly what is needed for for intranet use where, for example, communications with a company's inventory system is to be limited to company employees. Changing the message also prevents other network users from casually connecting to the company system, so that the shared files will not be available outside the private network.

It may be advantageous in creating such a private network or intranet to have all users initially connect to or Ping a designated “seed server” computer which is connected to all of the other computers in the intranet. The seed server Pings them and they all return Pongs to the user computer entering the intranet. As a result, the seed server defines the intranet.

The way that Pings and Pongs are used to discover active nodes is inherently inefficient. Instead, the Ping and Pong concept can be combined so that the user upon entering the network can discover the network topology by monitoring the packets of other servents or by being provided it from a seed server. This reduces network traffic and bandwidth requirements significantly by reducing the number of packets required for network discovery.

The existing protocol routes packets from computer to computer in a chain on their way to their destination. However, in most cases it would be more efficient to attempt to deliver packets directly from the computer with the content to the computer requesting it, using the more complex routing scheme only when necessary. Thus, the requesting computer can identify itself to the computer with the content and ask for a direct download. Further, security, encryption, digital certificates, authentication, reporting and QOS can be added to the servent to make its P2P communications even more compelling for business and consumer use.

P2P networks have many benefits. They permit files to be located without the need to know the machine, office, or country, in which they are located. P2P helps unify networks by creating a virtual “search space” where all searchable documents can live. The decentralized nature of P2P reduces management costs and empowers individuals to administer content within their own area of specialization or interest. Obviously, P2P would be much more compelling if the contents of the files being shared could be searched in addition to their file names. This can be achieved by providing a unified metadata system. Further, advantage can be taken of the protocol's ability to search the complete file path. If a document is stored on disk as “\Marmor\Services\Agreements\Master Service Agreement.doc” a search will match any part of its complete path, making it much more likely that the document will be returned in a relevant search.

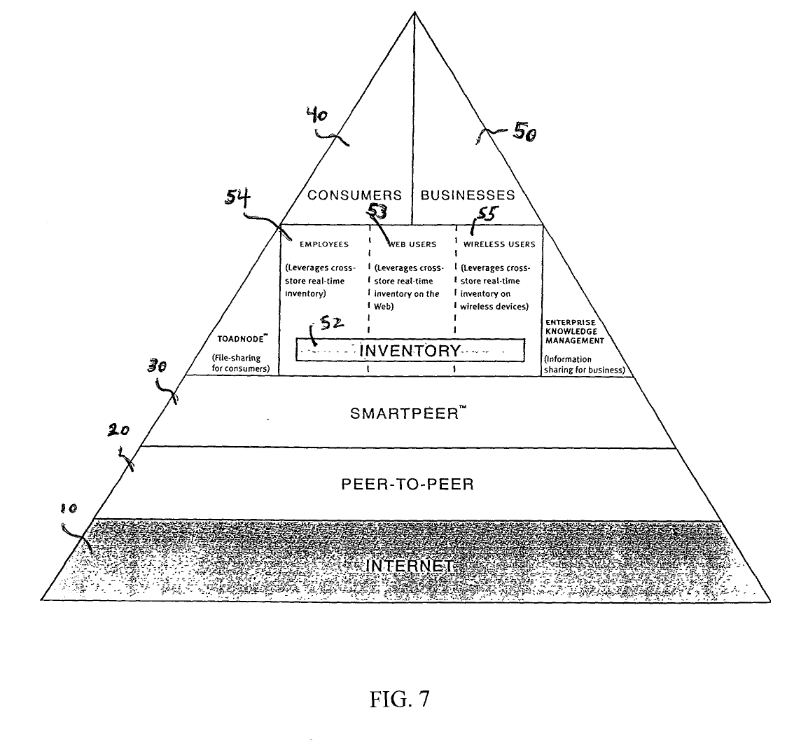

With the foregoing description of P2P networks, it is now possible to describe their use in providing typical commercial transactions. As shown in FIG. 7, the Internet 10 serves as the fundamental platform on which specialized P2P networks 20 with servents 30, like Toadnode™ or SmartPeer™ operate. The servent is used on the personal computers of consumers 40 and the inventory system computers of businesses 50. If the businesses or merchants allow their shared files on the network to include direct inventory information 52, other network users, e.g., consumers, can search this information directly over the P2P network without having to know the IP address of the merchant or to search the entire Internet with a search engine.

As a result of the present invention, a web user 53 from his desktop computer, can conduct simultaneous searches of several databases at one time. As shown in FIG. 3, the query from computer 1 is sent to computers 2 and 3 at the same time. While each of these computers checks its database for the requested Homer file, the query is simultaneously passed onto computer 4, 5 and 6, which also conduct searches. Thus, searches are rapidly conducted of the inventory databases of numerous stores of a merchant, and numerous merchants, both nationally and internationally across the Internet.

If instead of a customer, the PC is used by an employee 54 of the merchant, the employee can conduct searches of the inventory at his own store, other stores of the merchant and even the stores of competitors worldwide. If desired, the network can be limited to store employees so that it becomes an intranet. In such a case, only the inventory of the store chain is available. Nevertheless, this allows for very rapid cross-store real time inventory review, because the number of computers in the intranet is much smaller than all of the computers connected to the general network. Further, by changing the handshake, and having different categories of shared files, both internal and external searches can be conducted at the option of the user.

For those with mobile access to the Internet, access to both intranets and the entire network is possible. However, an additional advantage can be achieved. The responses received in response to a query can either be ranked or filter according to geography, e.g. distance from the current location of the user.

In order to implement this feature, the merchant needs to provide information in his inventory data base as to the geographical location of the inventory, e.g. the locations of various stores having inventory by ZIP code or street address.

Next, in making an inquiry, the user interface can be set up to request that the user identify his current location, e.g. by ZIP code, street address, etc. As an alternative, the users location can be detected automatically if his mobile device is equipped with a GPS transponder. Further, if a cellular provider participates, a cellular phone user can be located within a small distance by triangulating the signal strength from the phone at surrounding cell locations. Even if not located to a high degree of accuracy, general positional information can be obtained if the cellular service provider merely identifies the location of the cell which is handing the call.

Once the location has been determined, the results of the query can be ranked as to how close the product is to the user's current location. Thus, if a customer is already shopping and makes a request for a particular product, he can be directed to the closest store that has the product, or at least to those stores in the same ZIP code that have the product. If a filter is used, the display of responses can eliminate those from locations considered too remote. The filter is adjustable, e.g., so that if it is set at one mile and there are no responses that pass the filter, it can be changed to 10 miles, so that at least some results are displayed.

While the mobile user receives the maximum benefit of the geographical ranking and filtering, a stationary user also can make advantageous use of this feature. For example, it would be helpful to a desktop user to know how close to his home or office the product can be found.

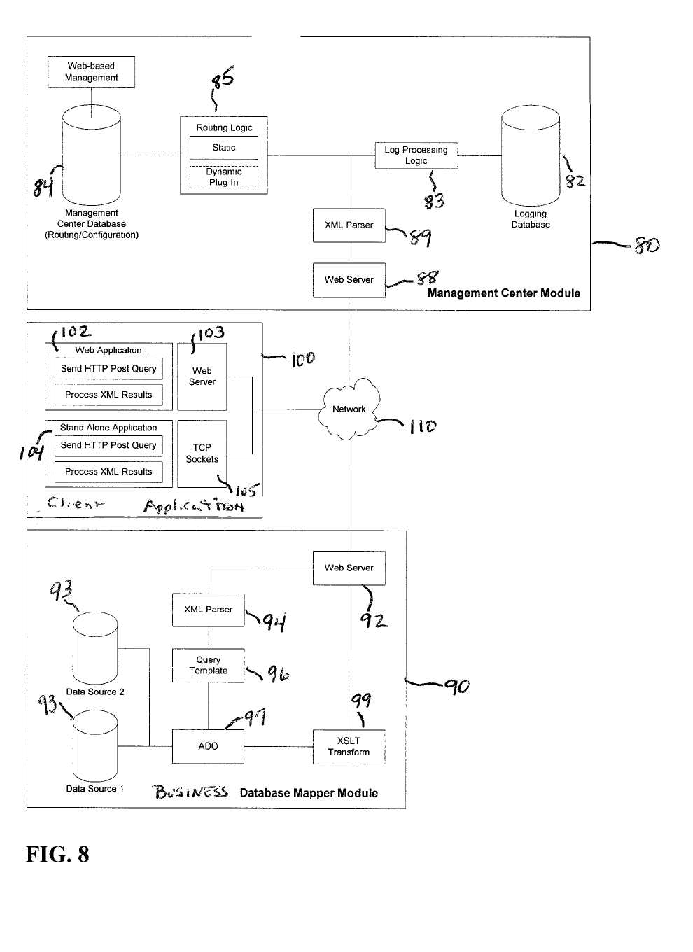

The basic hardware and software structure for the environment of the present invention is shown in FIG. 8. The system of the present invention is divided into three primary modules, the Management Center Module 80, the Business Database Mapper Module 90, and the user or Client Application 100. The Management Center Module is responsible for logging all system usage events, selecting the appropriate Database Mapper Modules for a given query and providing a web-based system management tool. The input to the Management Center Module comes from Client Application 100 which is provided with P2P software. This can be either a web application or a stand-alone application. The output of the Management Center Module is supplied to the Business Database Mapper Modules 90. The Database Mapper Module 90 is located at each information provider, e.g., each business in the system. It is responsible for the following three functions:

1. translating the incoming query into a format acceptable by the information provider's databases;

2. transforming the information provider's database output into an XML global conceptual schema for transmission to the client; and

3. propagating query requests to other Database Mapper Modules.

The system must be integrated with the Client Application 100 so that they communicate in the same format.

The Client Application 100 has two primary responsibilities:

1. to transmit query requests to the system, and

2. to receive query results and error messages from the system

The Client Application may be either a web-based application, such as an ASP or PHP site, or it may be a traditional program such as a Win32 application. There are a number of fields that the client or consumer must post to the P2P system. These fields are required to be posted as an XML document, which is the standard for communication over the network.

The Management Center Module 80 controls a database 82 that retains the records of the queries and logs all other system usage events as presented to it by log processing logic unit 83. These records may provide a means for the network operator to bill participating users and/or businesses for the services of the network. As an alternative business model, the network manager can bill flat rates to participating businesses, charge merely for the initial software and hardware installations, or charge a percentage of sales consummated over the network.

All participating businesses or information providers are registered in the Management Center Module's logging database 82, which can be an internal MSDE-based system supplied with the software or an external SQL server database. Further, certain configuration parameters such as URI, and level of logging detail required, must be defined. The Management Center Module 80 may be configured to support Minimal, Detailed, or Debug level logging. In general, Detailed and Debug levels of logging capture both outbound requests as well as success or failure status provided by the Database Mapper Modules 90. Minimal level logging captures only outbound requests and error conditions. Incoming log requests are parsed and the data is inserted into the logging database.

The system also includes a database 84 that stores routing and configuration information for the system. This information is used by routing logic unit 85 which indicates, in response to any query, which Database Mapper Modules should be contacted. Further, communication to and from the Management Center Module over the Network 110 is by means of a web server 88 and an XML Parser 89.

When the Management Center Module 80 receives a query request from the Client Application 100 over the Network 110, it must identify a list of Database Mapper Modules 90 to be queried. There are two methods that the Management Center Module can use to construct this list. The method is chosen based on the configuration of the Management Center:

1. Static Method: Database Mapper Modules are chosen based on their inclusion in groups specified in the Management Center Module's Routing Database.

2. Dynamic Method: Database Mapper Modules are chosen by a component “plug-in” responsible for making this decision. The default component supplied with P2P software such as SmartPeer™ may use geographic information, e.g., latitude, longitude and maximum acceptable distance to make this decision. Additional customer-supplied components may be added and the default component may be replaced.

The Client Application 100, as noted above, can either be a web-based application 102 operating through a web server 103 or a stand alone Windows application 104 operating through TCP sockets 105. Both types of application can post a query to the network and process the results, which typically will be in XML format.

The Database Mapper Module 90, which controls the merchant's data, may be an ISAPI DLL that is designed to translate incoming query requests into a format acceptable by its database, transform the output from the database into a global conceptual schema for transmission to the Client Application, and propagate query requests to other Database Mapper Modules. The Database Mapper Module also transmits status and error information to the Management Center Module 80.

In order to make available to users the inventory of a business, or other information of an information provider on the network, the web server 92 of the business' Database Mapper Module 90, which represents the presence of the business on the network, must be provided with the system software of the present invention, which includes P2P communications software. As shown in FIG. 8, the business' Database Mapper Module provides access to two sources of information 93, i.e., Data Source 1 and Data Source 2. Queries from a user system 100 travel over the network 110 and are received by the web server 92. It directs them to XML Parser 94, which separates out the relevant query, e.g., “Homer.” The query term is applied to a Query Template 96 which determines from a directory or index of the database if there is a match, and if so, where the related information is located in the Data Sources. The output of Template 96 is interpreted by the Active Data Object (ADO) Recordset unit 97 which controls access to the data. The data is retrieved as a Document Object Model (DOM) and sent to XSLT Transform unit 99. This DOM object is then transformed by unit 99 into a second DOM object by executing an XSLT transform. The resulting DOM object, which is now in a standardized schema, is converted to UTF-8 encoded text and transported via HTTPS to the client over the Network to the requesting user 100.

Errors, events and status messages are transmitted via HTTPS to the Management Center Module 80 according to the specified level of logging detail. Further, all parameter elements posted with the query will be returned to the user Client Application 100 along with any relevant result sets. The Client Application 100 must “listen” for the result data, which will be posted as an XML document.

The system uses the HTTPS protocol for communication between modules. Thus, the network infrastructure must be configured to allow this type of traffic to pass. The HTTPS protocol adds a level of security to all data transmissions by encrypting the data stream. All user validation must be handled by the Client Application or website that communicates with the system. Where possible the management of the system is centralized at the Management Center Module 80.

As can be seen, the present system facilitates distributed data querying across dissimilar networks and database platforms. It is designed to allow an individual who needs comprehensive information to simultaneously search a large number of diverse data sources. Such a system is useful in a variety of commercial markets. One includes large industrial applications—particularly inventory tracking and reporting. Another includes multi-national corporate knowledge management applications—particularly the unification of domain-specific information, such as medical records, human resource records and engineering data. However, the technology of the invention can be applied effectively to virtually any industry and is particularly meaningful where near real-time access to many, geographically dispersed data repositories is a priority.

The system effectively leverages a business' existing data and information systems (for example inventory, point-of-sale, transactions, customer records, etc.) through a highly customizable query processor. It has the effect of unifying the data stored on each database, allowing each data-source to be queried simultaneously through the network. Thus, employees and/or customers can query thousands of systems simultaneously, through a single query. It is particularly useful whenever there is a need to query more than one database at the same time.

Using the system it is possible to configure it to query pre-defined groups of databases, or to use a custom algorithm to determine which databases (and even which queries on which databases) will be executed. This is useful for building certain types of applications, such as inventory systems, where the user may want to use a dynamic attribute (the time of day, authentication status, user priority, etc.) to determine which systems will be queried. For example, queries may be limited to certain systems according to geographic proximity. This would allow a query such as “show me the inventory of part Q23R7 within 15-miles of distribution center number 4” to be run.

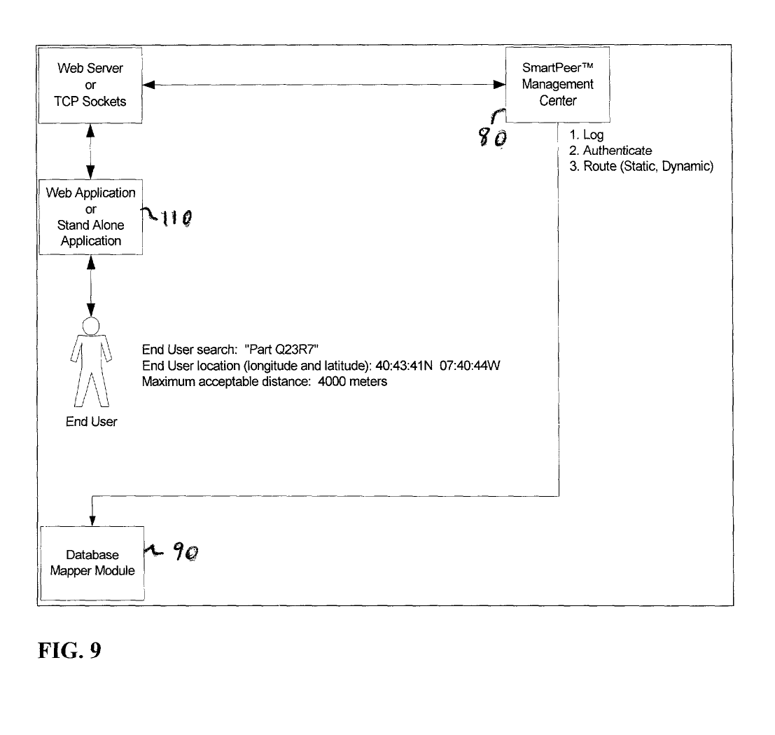

This is an example of a dynamic query and it is illustrated in FIG. 9, where the end user, utilizes the application 100 to place a search on the network which defines the part number and gives the user's location. Further a filter is set with an acceptable maximum distance of 4000 meters. This can be achieved with a plug-in module which is used to route the query based on distance. In carrying out the search, the query information is logged into the Management Center Module 80. It in turn generates a list that contains the Internet addresses of Database Mapper Modules 90 located within 4000 meters of the end user. In a static query, the list of Database Mapper Modules would be obtained by doing a lookup in the Management Center database. However created, this list is then sent to the root Database Mapper Module 90.

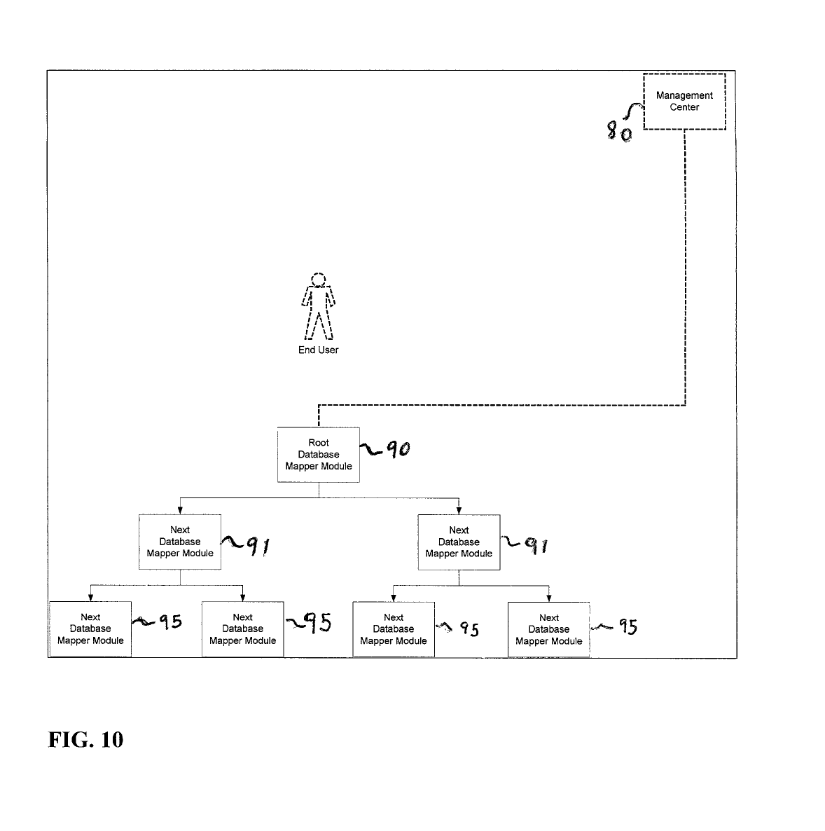

Along with the end user's query, the root Module 90 also receives the list of other Modules to be queried. It uses the list to build an in-memory binary tree used for routing. Then the root Database Mapper Module 90, uses the tree to distribute the end user's search (peer-to-peer according to the binary tree formation) to the next level of Database Mapper Modules 91 in the tree created by the list provided by the Management Center 80 (FIG. 10). This second level is also provided with tree information so that it can send the information to a third level of Module 95, and so on. Thus the search proceeds over the ever expanding binary tree utilizing multiple paths simultaneously until complete. The Management Center 80 logs all search activity.

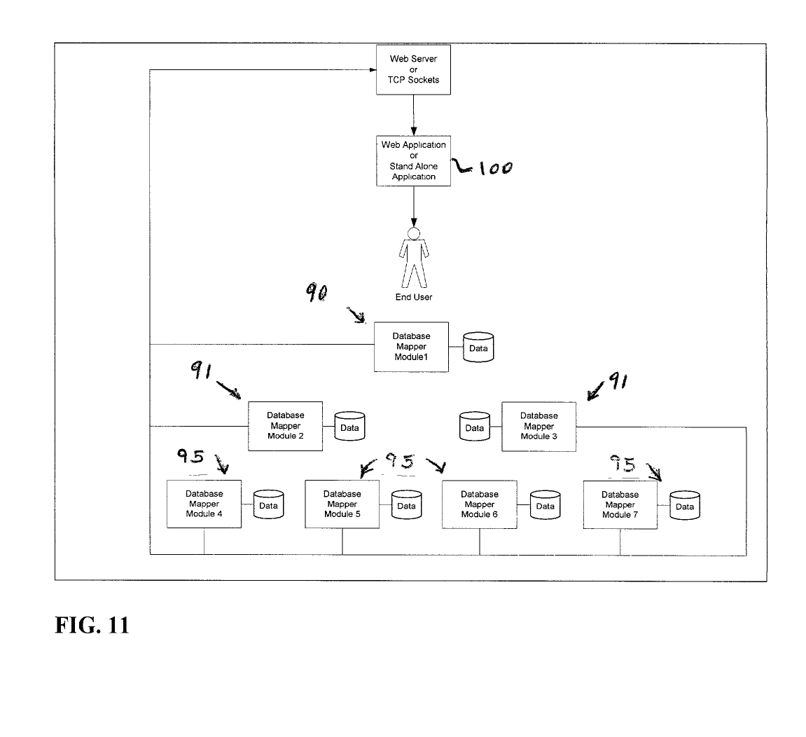

As shown in FIG. 11, each Database Mapper Module's database (in the list provided by the Management Center) is queried. The search results are transformed into a Global Conceptual Schema for this particular query and are sent back to the end user.

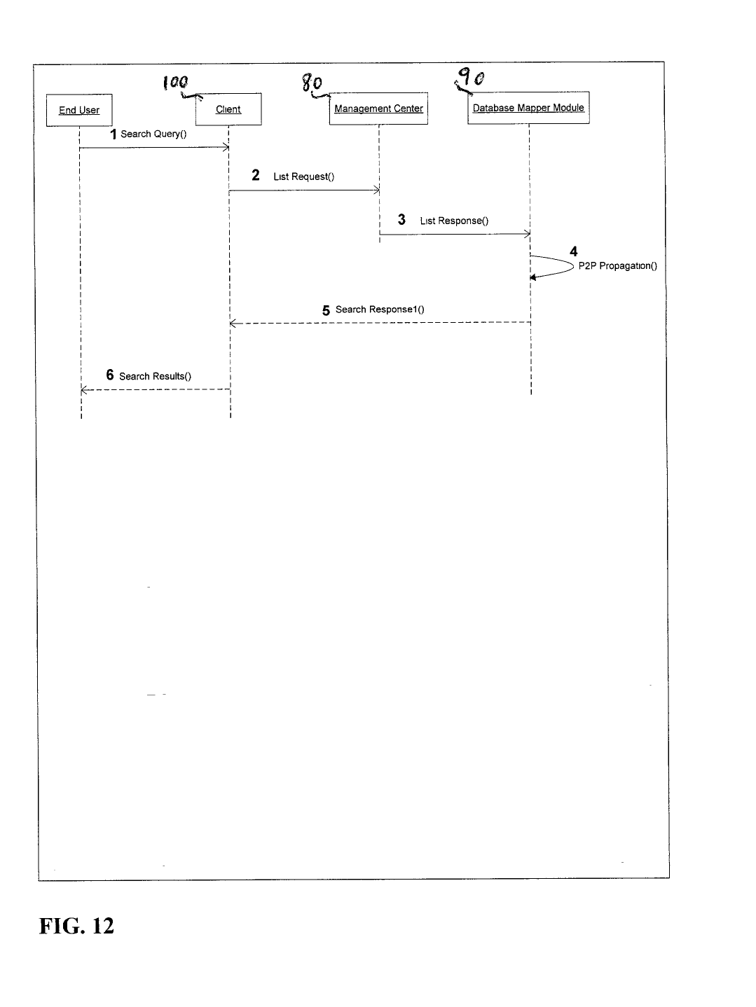

The routing of the messages is illustrated in the messaging sequence diagram of FIG. 12. As noted, in step 1 the end user creates the search request and inputs information on geographic location (e.g., 40:43:41N, 07:40;44W). Part of the search request can include a maximum acceptable distance of, e.g., 4000 meters. This is query is taken by the Client Application 100. In step 2 application 100 sends the query to the Management Center 80, which causes it to construct a list of databases which meet the criteria. The list is provided in terms of GUID values, e.g. (49n41.74w0.GUID, 100 m), (40n42.73w11.GUID, 200 m), (40n43.72w0.GUID, 243 m), (40n44.71w0.GUID, 543 m), which are sent to the Database Module(s) 90. Step 4 shows that the query is propagated to the appropriate databases. In step 5 a series of responses are received, e.g.,

a. (40n41.74w0.GUID): 2 matches=(match 1), (match 2)

b. (40n43.72w0.GUID): 1 match=(1 match)

. . .

In step 6 these results are formatted and delivered to the end user.

The system of the present invention enables industry to provide real-time part and product availability information to anyone who needs to know the nearest location that has a particular part or item in stock. This includes enabling customers to identify where the product they need is in stock, at the nearest location. Further, it makes corporate information stored in multiple locations available from a single point. Potential uses include the unification of sales information, medical records, human resource information, engineering documents, transaction records, etc.

The different ways in which different end-users may use the system are illustrated with the following examples. The first example is of a situation in which a manufacturer and suppliers share data to increase efficiency and reduce costs. Assume a manufacturer relies on four suppliers to provide parts and sub-assemblies for its line of products, and that the manufacturer has three warehouses and two manufacturing facilities, each with its own local inventory system. Each system is different and they are not directly connected to one another.

Faced with this situation under the prior art, reports generated from each facility would have to be manually reconciled. After assembling the data for each of the facilities, product demand would be projected and purchase orders created for each of the four suppliers. This process would take quite a bit of time, leading to occasional shortages of parts and lost sales opportunities. However, by using the system of the present invention with the manufacturer's and suppliers' existing inventory systems, the manufacturer is able to query all the facilities at the same time—providing a real-time view of parts and completed product inventory. By setting up special queries on a password protected Website, the manufacturer is able to give each supplier access to the appropriate part inventory across their organization. This simple system allows the manufacturer to implement a basic vendor-managed inventory program at very low cost, and with increased transparency and more timely transfer of information between the manufacturer and its suppliers.

In another example, an employee uses the system to check cross-warehouse real-time inventory. In such a case the employee of a wholesale supply business with 13 warehouse locations spread over a wide geographic is charged with the responsibility for helping customers locate products. The employee is located at one of the warehouses and he takes in-person and telephone inquiries. In response to an inquiry he first checks to see if a particular item is available in his warehouse.

In a prior art environment, if the employee determined that the product was not available at his location, he would have to call the other warehouses to locate the merchandise for his customer. Using the present invention, he is now able to check product availability in all of the warehouses simultaneously, and can even tell customers the most convenient location where the product is in stock.

In a still further example, a Human Resources Department of a business can use the system of the present invention to unify independent corporate systems. Assume the company has half of its benefits database running on an Oracle system (for the parent company in one state) and the other half running on a proprietary HR system that uses a Fox Pro database located in another state (e.g., as a result of a recent merger). There are similar databases that contain employee evaluations, salary history and even a database that contains Hazardous Materials Certifications—a special system required by the government. Thus, the business has to decide if it should invest in an enterprise HR system—a very expensive system that will take a long time to install and may not satisfy all the company's requirements—or try to connect each of the existing systems together so that employees will have access to all the information they require.

By integrating P2P software and the present system with each of the HR database systems, the company is able to create a Web-based interface that is capable of querying each of the databases simultaneously—using the Internet to inexpensively connect each location. This is accomplished even though the databases are different. This solution is much less expensive than purchasing and customizing a new system and has the capacity to expand easily. Each employee simply uses a page on the intranet to access the data they require—unaware that there are many systems being queried.

The system of the present invention also provides customers with the ability to make a purchase on the Internet and get the merchandise at a convenient time and location, instead of waiting a day or more, as is currently the case. This would give on-line merchants with local stores, e.g. Barnes & Noble.com, a significant advantage over their competitors, who do not have land-based assets to leverage, e.g. Amazon.com. In particular, the inventory in the various stores of Barnes & Nobel would be available in an on-line search using the present invention. Rather than wait for a delivery from Amazon.com, the user would be directed to the nearest Barnes & Nobel store that has the desired book. Since the book can be purchased on-line using the present invention, all the user needs to do is pick it up, thus avoiding checkout lines, or have it shipped from a nearby location. Other merchants who can use the present invention to leverage their land-based assets to create a larger more loyal customer base by linking their existing POS or store-based inventory systems to the Internet, include Borders, J. Crew, Gap, Banana Republic, Coach, Virgin, Tower Records, etc.

With the present invention, consumers can search for and compare products in thousands of businesses and locations simultaneously, through a single query. Because the information returned comes directly from a company's inventory and POS system, it is always up-to-date. It is further possible for customers to make very specific parametric searches based on a product's particular characteristics. When customers know exactly what they want, this becomes a more powerful search mechanism than traditional Web-based search engines.

For example, customers searching for apparel might include requirements such as size, color and price. Customers shopping for a car might include engine displacement, cylinders, number of doors, etc. The system permits these highly specialized searches to be performed across thousands of servers, all over the world, simultaneously. Thus, a 500 store retail company could easily allowing shoppers to find the products they want at the most convenient location.

Companies that have a sophisticated Web presence can easily add the ability to fulfill purchases from their physical stores by using the system, and limiting its search results to participating stores.

Using positioning features in wireless devices, the system transmits a shopper's location and matches the results of product searches by proximity of the product to the shopper. This allows a shopper to find the closest, cheapest copy of the latest best seller as he walks down the street. By connecting directly to a merchant's business via the Internet, with his wireless device, the customer will be able to complete a purchase or put the best seller on hold while he walks over to the store to pick it up.

The more people use their wireless devices, the more the wireless industry benefits. Because the present invention is a relatively inexpensive way for companies, especially smaller local ones, to provide their businesses with e-commerce capability, there will be vastly more companies doing so. With virtually every company making its products available over the Internet, there will be more reasons for consumers to use the wireless device. For example, in the environment created by the present invention, nearly every local bookseller (whether independent or part of a large chain) will be accessible to Internet users. As a result, wireless Internet users will have more choices that are geographically convenient to them. A wireless user walking down the street in Manhattan can search for that best seller he has been wanting to read, and find the copy that is closest. This significantly extends the utility of wireless devices into the e-commerce market by enabling users to locate and purchase local merchandise immediately, rather than having to wait a day or more for it to come from a distant fulfillment center.

Customers can use any mobile device that can access the Internet. This includes a cellular or wireless telephone, or a PDA. Customers using a wireless device can consummate the transaction by having the transaction amount billed to their credit card or having it added directly to the wireless telephone bill. There is no need for credit card or other sensitive payment information ever to be transmitted if the purchases are billed to the phone. By using a digital receipt or order confirmation number, easily verifiable by the merchant, the customer can pick up the purchase at the store, or have it delivered to a convenient address.

While the invention has been particularly shown and described with reference to an exemplary embodiment thereof, it will be understood by those skilled in the art that various changes in form and details may be made therein without departing from the spirit and scope of the invention.

We claim:

1. A system permitting simultaneous searching of multiple databases, comprising:
a network of information provider computers having associated databases of information, said information provider computers being connected according to a peer-to-peer protocol; said information provider computers having an index of information on their associated databases and being able to check a query against the index and send the information back over the network if it is located;
at least one user computer being connected to the network according to the peer-to-peer protocol, said user computer being adapted to generate at least one query for information and to send it over the network, said query containing geographical location information, said user computer being adapted to receive a response to the query over the network in the form of the requested information; and
a management center processor connected to the network according to the peer-to-peer protocol, said management center processor receiving the query from said user computer over the network, formulating routing information based on said query and forwarding the query over the network to designated information provider computers based on the routing information in response to the receipt of the query, said management center receiving information responses from the information provider computers over the network and forwarding them to the user computer over the network.

2. The system of claim 1 in which the routing information is in the form of a binary tree of the designated information provider computers.

3. The system of claim 1 in which the query is for information about a physical item, contains specific geographic location information and distance limits; and
wherein the routing information limits the designated information provider computers to those with information which relates to items located within the distance limit from the specified geographic location.

4. The system of claim 1 in which the user computer has a wireless connection to the network.

5. The system of claim 3 in which the user computer is a portable computing device with a wireless connection to the network, and the specific geographic location is the current geographic location of the user computer.

6. The system of claim 5 in which the portable computing device is one of a cellular phone, a portable phone and a personal digital assistant with a wireless Internet connection.

7. The system of claim 1 in which the network includes the Internet.

8. The system of claim 7 in which the user computer supports at least one of an Internet based application and a stand alone application, either of which provides a user interface and peer-to-peer communications.

9. The system of claim 7 further including a web server of the information provider which hosts an Internet web page of the information provider.

10. The system of claim 1 in which the management center processor further includes a logging database which stores a log of queries and responses which pass through it.

11. The system of claim 1 in which the information provider is a merchant and the database is part of one of an inventory system and point-of-sale system of the merchant.

12. The system of claim 1 in which management center processor includes a routing database and the routing information is created statically from a lookup table in the routing database of the management center processor.

13. The system of claim 1 in which in which the management center processor includes a routing database and the routing information is created dynamically by applying limitations on information from a lookup table in the routing database of the management center processor.

14. A method for simultaneous searching of multiple databases associated with a network of information provider computers, said information provider computers being connected according to a peer-to-peer protocol, said information provider computers having an index of information on their associated databases and being able to check a query against the index and send the information back over the network if it is located, comprising the steps of:
generating, at a user computer connected to the network according to the peer-to-peer protocol, at least one query for information which includes geographical location information;
sending the query over the network to a management center processor in peer-to-peer protocol communication with the network;
formulating routing information based on said query;
forwarding the query over the network to designated information provider computers based on the routing information;
comparing the query to the index of information at the information provider computer to determine if the requested information is on its associated database;
if the requested information is on the database of the information provider, formatting it into a predetermined form;
sending the formatted information back to the management center; and
sending the formatted information from the management center to the user computer.

15. The method of claim 14 wherein the routing information is in the form of a binary tree of the designated information provider computers.

16. The method of claim 14 in which the query is for information about a physical item, contains specific geographic location information and distance limits; and
wherein the routing information limits the designated information provider computers to those with information which relates to items located within the distance limit from the specified geographic location.

17. The method of claim 14 in which the user computer has a wireless connection to the network.

18. The method of claim 17 in which the user computer is a portable computing device with a wireless connection to the network, and the specific geographic location is the current geographic location of the user computer.

19. The method of claim 18 in which the portable computing device is one of a cellular phone, a portable phone and a personal digital assistant with a wireless Internet connection.

20. The method of claim 14 in which the network includes the Internet.

21. The method of claim 20 in which the user computer supports at least one of an Internet based application and a stand alone application, either of which provides a user interface and peer-to-peer communications.

22. The method of claim 21 further including a web server of the information provider which hosts an Internet web page of the information provider.

23. The method of claim 14 further including the step of storing a log of queries and responses which pass over the network.

24. The method of claim 14 in which the information provider is a merchant and the database is part of one of an inventory method and point-of-sale system of the merchant.

25. The method of claim 14 in which the step of formulating the routing information is static and includes looking up in a table routing information in a database of the management center processor.

26. The method of claim 14 in which in the step of formulating the routing information is dynamic and includes:
looking up in a table routing information in a database of the management center processor, and
applying limitations on information from the lookup table.
